(19) United States
(12) Patent Application Publication
(10) Pub. No.: US 2008/0094517 A1
(43) Pub. Date: Apr. 24, 2008

(54) Image Processing Apparatus and Image Processing Method

(75) Inventors: Yoshihisa TAKEUCHI, Kyoto-shi (JP); Katsushi MINAMINO, Kyoto-shi (JP)

Correspondence Address: HOGAN & HARTSON L.L.P., 1999 AVENUE OF THE STARS, SUITE 1400, LOS ANGELES, CA, 90067, US

(73) Assignee: MURATA MACHINERY, LTD., Kyoto-shi (JP)

(21) Appl. No.: 11/875,722

(22) Filed: Oct. 19, 2007

(30) Foreign Application Priority Data
Oct. 19, 2006 (JP) 2006-284810
Oct. 19, 2006 (JP) 2006-284811

(51) Int. Cl. H04N 9/64

(52) U.S. Cl. 348/649; 348/E09.037

(57) ABSTRACT

An image processing apparatus includes a hue specifying unit, a pixel extracting unit and a luminance data converting unit. The hue specifying unit generates hue specification information that specifies a hue to be converted on a basis of a user operation. The pixel extracting unit extracts pixels having a hue specified by the hue specification information from a color image on a basis of the hue obtained from chromaticity data. The luminance data converting unit carries out processing on luminance data of pixels extracted in the pixel extracting step using a function which lowers an upper limit value of luminance and increases in a monotone within a predetermined range including the upper limit value to convert the luminance value, so that a monochrome image is generated from the color image.

### CROSS-REFERENCE TO RELATED APPLICATIONS

This application claims priority under 35 U.S.C 119 to Japanese Patent Application No. 2006-284811, filed on Oct. 19, 2006, and Japanese Patent Application No. 2006-284810, filed on Oct. 19, 2006, which applications are hereby incorporated by reference in their entireties.

### BACKGROUND OF THE INVENTION

1. Field of the Invention

The present invention relates to an image processing apparatus and, more specifically, to an improved image processing apparatus which carries out image processing on a color image read from an original by an image pickup apparatus such as a scanner and outputs a monochrome image.

2. Description of the Related Art

In recent years, an image reading apparatus has been proposed that reads an original or the like with an object appearing in a specific color erased therefrom. In this image reading apparatus, a read image is generated without reading an object which appears in a predetermined color. Accordingly, an object such as guide lines preprinted in a specific color, for example, with red ink, in the original can be erased from the read image.

Recently, an image processing apparatus has also been proposed that allows a user to specify parameters of hue, color saturation, lightness, and luminance, and convert luminance components of pixels which exist in the range of the specified hue, color saturation, lightness, and luminance into a white level (the upper limit value of luminance).

In recent years, an image processing apparatus has been proposed that converts a specific color in a color image read from an original into a white level to generate a monochrome image. The image processing apparatus includes an image reading unit that reads an image from an original, a color specifying unit that specifies a color, and an image processing unit that converts the specified color into a white level to generate a monochrome image. A first image processing apparatus carries out processing to extract pixels within a range of predetermined hue, color saturation, and lightness and convert the luminance components in the pixels into the white level. Accordingly, a monochrome image in which pixels in a specific color are whitened is obtained from a color image, so that an object in the original in the specific color, for example, guide lines preprinted in red ink is erased from the image data.

On the other hand, a color printing apparatus has been proposed that increases color saturation of pixels having a hue within a predetermined range to emphasize a specific hue, and print a color image. This color printing apparatus allows a user to specify the range of hue in which the color saturation is to be increased in advance, and increases the color saturation of pixels having the hue within this range, so that the printed quality of the color image is improved.

### BRIEF SUMMARY OF THE INVENTION

Image data after image processing is normally binarized in the number of tones which represents the luminance component, and is printed as a monochrome image including binary data for each pixel. When binarizing the luminance component, pseudo tone display processing (halftone display processing) such as a dither method is carried out to reproduce the change of a monochrome multi-valued tone in binary. In the image processing apparatus in this configuration, processing to convert into the white level is not carried out on the luminance components of the pixels out of the range of the hue, color saturation, lightness, and luminance specified by the user, rather, processing to convert into the white level is carried out only on the luminance components of the pixels within the user-specified range. Therefore, luminance components of pixels having the hue, color saturation, lightness, and luminance close to the user-specified range are not whitened and are outputted as image data. Consequently, there is a problem in that the boundary of the user-specified range has a high profile when printed as the monochrome image, so that it gives an unpleasant feeling to viewers.

In view of such circumstances, it is a first object of the present invention to provide an image processing apparatus that adequately whitens a specific color when printing a color image read from an original in monochrome, without causing an unpleasant feeling to viewers. Specifically, an image processing apparatus is provided in which a boundary between black and white is restrained from having a high profile when being printed for pixels having a user-specified hue, when carrying out processing to convert a color image including luminance data and chromaticity data for each pixel into a white level. The image processing apparatus of the present invention also prevents the boundary between the user-specified hue and a hue close to the user-specified hue in a color space from having a high profile.

When printing a color image read from an original by an image pickup apparatus such as a color scanner in monochrome, it is very convenient if it is possible to print while emphasizing a specific portion such as characters written in red in an original printed in black. In particular, if it is possible to print while emphasizing a specific portion such as characters written in red by increasing the density thereof and reducing the density of other portions printed in black, the portion written in red and the portion printed in black are conveniently distinguished even in the monochrome image.

In view of such circumstances, it is a second object of the present invention to provide an image processing apparatus which is capable of emphasizing a portion written in a specific color when printing a color image read from an original in monochrome. In particular, the present invention provides an image processing apparatus which is capable of emphasizing pixels having a user-specified hue when obtaining a monochrome image from a color image having luminance data and chromaticity data for each image. The present invention also provides an image processing apparatus which is capable of keeping the boundary between a user-specified hue and a hue close to the user-specified hue in the color space from having a high profile.

In order to achieve the first object, an image processing apparatus carries out image processing on a color image having luminance data and chromaticity data for each pixel read from an original and outputs a monochrome image. The image processing apparatus includes a hue specifying unit, a pixel extracting unit and a luminance data converting unit. The hue specifying unit generates hue specification information which specifies a hue to be converted on the basis of a user operation. The pixel extracting unit extracts pixels having the hue specified by the hue specification information from the color image on the basis of the hue obtained from the chromaticity data. The luminance data converting unit carries out conversion processing on luminance data of pixels extracted by the pixel extracting unit to saturate luminance values higher than a first threshold value and increase luminance values lower than the first threshold value, so that a monochrome image is generated from the color image.

In this image processing apparatus, the hue specification information is generated on the basis of the user operation, and the pixels having a hue specified by the hue specification information are extracted from the color image read from the original. Then, processing to convert luminance data of extracted pixels is carried out, so that the monochrome image is generated from the color image. The luminance data conversion processing is processing to saturate luminance values higher than the first threshold value and increase luminance values lower than the first threshold value. In this configuration, the luminance data is converted according to the luminance value thereof and luminance values higher than the first threshold are changed to the upper limit value of the luminance for the pixels having the user-specified hue, the specific hue is whitened while keeping the boundary between the black and white from having a high profile when printed as the monochrome image.

In one embodiment, the luminance data converting unit brings luminance values in a range from the lower limit value to the first threshold value into correspondence with values obtained by multiplying the luminance values by a constant value.

In one embodiment, the luminance data converting unit saturates luminance values higher than the first threshold value, increases luminance values higher than a second threshold value which is smaller than the first threshold value and lower than the first threshold value, and brings luminance values lower than the second threshold value into correspondence with the same luminance.

In one embodiment, the pixel extracting unit extracts pixels having a color saturation larger than a third threshold value and does not extract pixels having a color saturation smaller than the third threshold value when extracting pixels from the color image on the basis of the hue obtained from the chromaticity data. In this configuration, extraction processing is carried out only on pixels having a color saturation larger than the third threshold value, and hence pixels having a small color saturation different from the user-specified hue are not extracted by mistake.

In one embodiment, a binarizing unit compares the luminance value of luminance data after conversion processing by the luminance data converting unit with a fourth threshold value and, on the basis of the result of comparison, generates binary data, so that the monochrome image including the binary data for each pixel is outputted.

In one embodiment, a luminance correcting unit carries out processing to convert luminance values existing in a first range including the lower limit value in the luminance data after conversion processing by the luminance data converting unit into the lower limit value, or to convert luminance values existing in a second range including the upper limit value into the upper limit value, so that the binarizing unit generates binary data on the basis of luminance data after conversion processing by the luminance correcting unit.

In one embodiment, a peripheral area specifying unit generates peripheral area specification information that specifies peripheral areas in a color space having a hue specified by the hue specification information on the basis of the hue specification information, so that the luminance data conversion unit converts luminance data in pixels in the peripheral areas specified by the peripheral area specification information with an increment of the luminance value smaller than the conversion processing to generate the monochrome image from the color image. In this configuration, since conversion of luminance data is adequately achieved also in pixels in peripheral areas of the user-specified hue, the boundary between the user-specified hue and a hue close to the user-specified hue in the color space does not have a high profile when printed as the monochrome image.

In order to achieve the second object, an image processing apparatus carries out image processing on a color image including luminance data and chromaticity data for each pixel read from an original and outputs a monochrome image. The image processing apparatus includes a hue specifying unit, a pixel extracting unit and a luminance data converting unit. The hue specifying unit generates hue specification information that specifies a hue to be converted on the basis of a user operation. The pixel extracting unit extracts pixels having the hue specified by the hue specification information from the color image on the basis of the hue obtained from the chromaticity data. The luminance data converting unit carries out processing to convert luminance on luminance data of pixels extracted by the pixel extracting unit using a function which lowers an upper limit value of luminance and increases in a monotone within a predetermined range including the upper limit value, so that a monochrome image is generated from the color image.

In this image processing apparatus, the hue specification information is generated on the basis of the user operation, and pixels having a hue specified by the hue specification information are extracted from the color image read from the original. Then, processing to convert luminance data of extracted pixels is carried out, so that the monochrome image is generated from the color image. The luminance data conversion processing is carried out by using a function which lowers the upper limit value of the luminance and increases in a monotone within the predetermined range including the upper limit value. In this configuration, since pixels having the user-specified hue are printed densely when being printed as a monochrome image since the luminance value in the vicinity of the upper limit value is lowered, the corresponding portion is emphasized.

In one embodiment, the luminance data converting unit brings the luminance values into correspondence with values obtained by multiplying the luminance values by a constant value.

In one embodiment, the luminance data converting unit brings luminance values existing in a range from the lower limit value to the first threshold value into correspondence with the lower limit value, and brings luminance values existing in a range from the first threshold value to the upper limit value into correspondence with values obtained by subtracting a constant value from the luminance values.

In one embodiment, the pixel extracting unit extracts pixels having a color saturation larger than the second threshold value and does not extract pixels having a color saturation smaller than the second threshold value when extracting pixels from the color image on the basis of the hue obtained from the chromaticity data. In this configuration, since extraction processing is carried out only on pixels having a color saturation larger than the second threshold value, and hence pixels having a small color saturation different from the user-specified hue are not extracted by mistake.

In one embodiment, a binarizing unit compares the luminance value of luminance data after conversion processing by the luminance data converting unit with the third threshold value and, on the basis of the result of comparison, generates binary data, so that the monochrome image including the binary data for each pixel is outputted.

In one embodiment, a luminance correcting unit carries out processing to convert luminance values existing in a first range including the lower limit value in the luminance data after conversion processing by the luminance data converting unit into the lower limit value, or to convert luminance values existing in a second range including the upper limit value into the upper limit value, so that the binarizing unit generates the binary data on the basis of the luminance data after conversion processing by the luminance correcting unit.

In one embodiment, the luminance data converting unit increases the luminance value for pixels other than those having a hue specified by the hue specification information.

In one embodiment, a peripheral area specifying unit generates peripheral area specification information which specifies peripheral areas in a color space having a hue specified by the hue specification information on the basis of the hue specification information, so that the luminance data conversion unit converts luminance data in pixels in peripheral areas specified by the peripheral area specification information with an increment of the luminance value smaller than the conversion processing to generate the monochrome image from the color image. In this configuration, since the conversion of luminance data is adequately achieved also in pixels in peripheral areas of the user-specified hue, the boundary between the user-specified hue and a hue close to the user-specified hue in the color space does not have a high profile when printed as the monochrome image.

According to the image processing apparatus in the present invention, since luminance data of pixels having a user-specified hue are converted according to the luminance value thereof and luminance values higher than a first threshold value are changed to an upper limit value of the luminance value, the boundary between black and white does not have a high profile when being printed as a monochrome image. Since the luminance data of pixels in the peripheral area having the user-specified hue is adequately converted, the boundary between the user-specified hue and a hue close to the user-specified hue in the color space does note have a high profile when printed as the monochrome image. Therefore, the image processing apparatus is able to whiten the specific color adequately when printing the color image read from the original in monochrome without causing an unpleasant feeling.

According to the image processing apparatus in the present invention, since the luminance value of pixels having the user-specified hue is lowered, a specific hue is printed densely when being printed as a monochrome image, so that the corresponding portion is emphasized. Since the conversion of luminance data is adequately achieved also for pixels in peripheral areas of the user-specified hue, the boundary between the user-specified hue and a hue close to the user-specified hue in the color space does not have a high profile when printed as the monochrome image. Therefore, the portion written in a specific color is emphasized when printing the color image read from the original in monochrome.

Other features, elements, processes, steps, characteristics and advantages of the present invention will become more apparent from the following detailed description of embodiments of the present invention with reference to the attached drawings.

### BRIEF DESCRIPTION OF THE DRAWINGS

FIG. 1 is a block diagram of an image processing apparatus, embodied as a digital multifunction peripheral, according to a first embodiment of the present invention.

FIG. 2 is a block diagram of a color scanner unit in the digital multifunction peripheral of FIG. 1.

FIG. 3 is a block diagram of an image processing unit of the digital multifunction peripheral of FIG. 1.

FIG. 4 is a block diagram of a monochrome image generating unit of the image processing unit of FIG. 3.

FIG. 5 illustrates a color space used when allowing a user to specify a hue in the image processing unit of FIG. 3.

FIG. 6 illustrates a hue area Al specified by the user and peripheral areas A2 in the image processing unit of FIG. 3.

FIG. 7 illustrates graphs B2 and B3 which represent a conversion table used for whitening by the image processing unit of FIG. 3.

FIG. 8 illustrates a graph C1, which represents a conversion table used for correcting the luminance for removing noise by the image processing unit of FIG. 3.

FIG. 9 is a flowchart of the operation of the image processing unit of FIG. 3.

FIG. 10 illustrates a graph B4 which represents another example of a conversion table used for whitening by the image processing unit of FIG. 3.

FIG. 11 illustrates a graph B5, which represents another example of a conversion table used for whitening by the image processing unit of FIG. 3.

FIG. 12 illustrates graphs D1 and D2 which represent conversion tables used for hue emphasis by an image processing unit according to a second embodiment of the invention.

FIG. 13 illustrates a graph D3 which represents another example of a conversion table used for hue emphasis by the image processing unit according to the second embodiment of the invention.

### DETAILED DESCRIPTION OF PREFERRED EMBODIMENTS

### First Embodiment

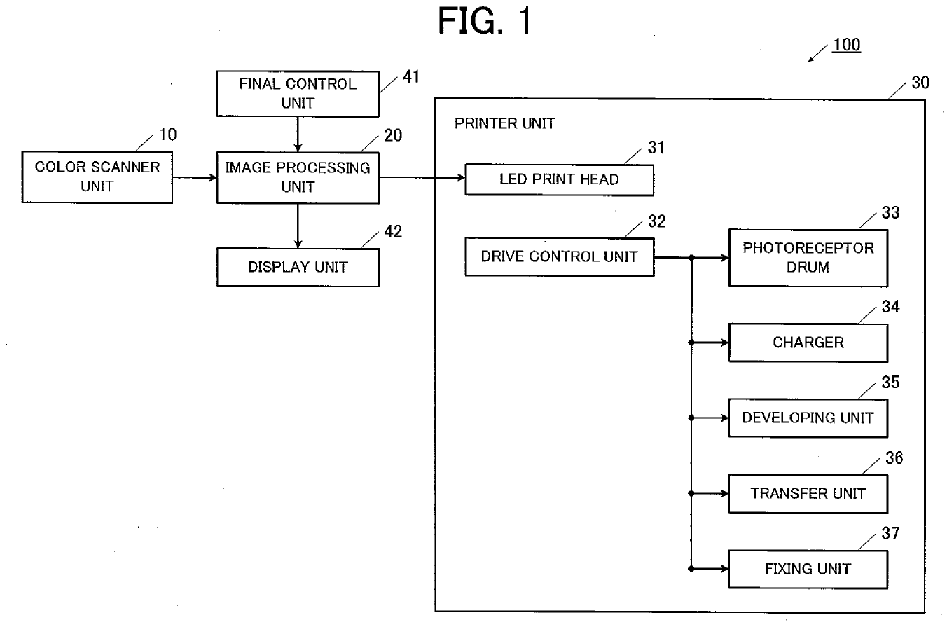

FIG. 1 is a block diagram of an image processing apparatus, embodied as a digital multifunction peripheral 100, according to a first embodiment of the present invention. Digital multifunction peripheral 100 includes a color scanner unit 10, an image processing unit 20 and a printer unit 30. The color scanner unit 10 is an image pickup apparatus for generating image data by irradiating an original to be read with light and receiving reflected light from the original. In the following description, it is assumed that manually written characters or printed patterns on the original are read by scanning the original (paper) with irradiated light in the paper feeding direction, and that color image data including luminance data for at least three different colors is generated.

The image processing unit 20 carries out processing to generate monochrome image data by changing the luminance value of luminance data of color image data read from the original by the color scanner unit 10, and then carries out an operation to output the generated monochrome image data to the printer unit 30. The processing to change the luminance value is carried out on the basis of a user-specified hue. The image processing unit 20 displays an input screen on a display unit 42 for allowing the user to specify the hue, and the hue is specified on the basis of an input signal from a final control unit 41.

The printer unit 30 is an output device for outputting the monochrome image data, and includes an LED print head 31, a drive control unit 32, a photoreceptor drum 33, a charger 34, a developing unit 35, a transfer unit 36 and a fixing unit 37. The LED print head 31 includes an LED array having a plurality of LEDs (Light Emitting Diodes) linearly arranged, and carries out an operation to irradiate the photoreceptor drum 33 with light on the basis of the monochrome image data supplied from the image processing unit 20.

The drive control unit 32 controls a printer mechanism including the photoreceptor drum 33, the charger 34, the developing unit 35, the transfer unit 36 and the fixing unit 37. The photoreceptor drum 33 is a cylindrical rotating body formed with a photoreceptive layer on the surface thereof, and is charged by the charger 34 uniformly on the surface thereof during the printing job. An electrostatic latent image is formed by irradiating the surface of the photoreceptor drum 33 charged in this manner with light.

The developing unit 35 carries out an operation to form a toner image by attaching a toner on the surface of the photoreceptor drum 33 on which the electrostatic latent image is formed. The transfer unit 36 carries out an operation to transfer the toner image formed on the surface of the photoreceptor drum 33 to a print sheet. The fixing unit 37 carries out an operation to heat and pressurize the print sheet on which the toner image is transferred to fix the monochrome image onto the surface of the print sheet.

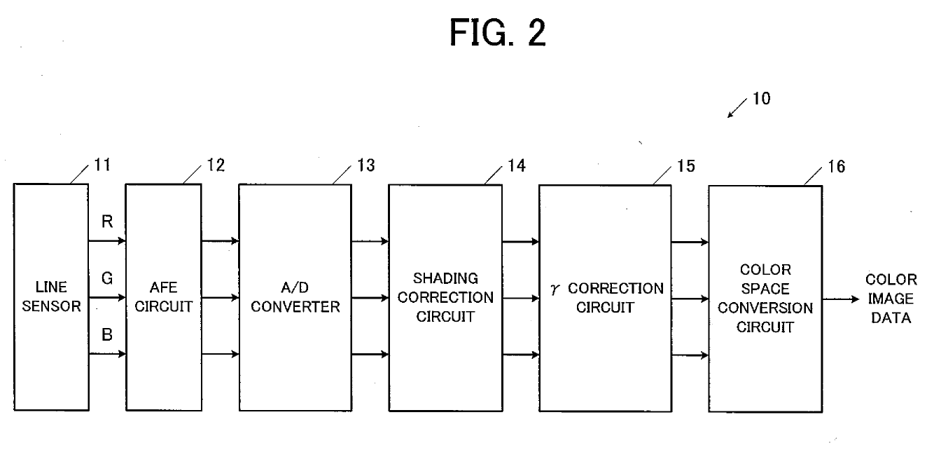

FIG. 2 is a block diagram of the color scanner unit 10 in the digital multifunction peripheral 100 in FIG. 1. The color scanner unit 10 includes a line sensor 11, an AFE (Analog Front End) circuit 12, an A/D converter 13, a shading correction circuit 14, a γ correction circuit 15 and a color space conversion circuit 16. The line sensor 11 includes a light receiving element array in which a plurality of light receiving elements such as CCD (Charge Coupled Device) are arranged on a straight line L, and carries out an operation to generate an analogue signal which represents the received light amount (luminance), for example, voltage signals for respective colors of R (red), G (green) and B (blue).

The AFE circuit 12 is an amplifier that adjusts the voltage level of analogue signals supplied from the line sensor 11 and outputs the same to the A/D converter 13. The A/D converter 13 is a converting element that samples the analogue signals supplied from the AFE circuit 12 at a predetermined sampling rate, and generates digital data. It is assumed here that luminance data including 8 bit (256 tones) data are generated for the respective colors of R, G and B.

The shading correction circuit 14 is a digital processing circuit that carries out processing to correct the luminance data for standardizing the amount of received light for the respective pixels in the line sensor 11. More specifically, a plurality of objects being formed in advance for correcting the shading and arranged in the line direction (the direction of the straight line L) and each having a known reflection coefficient, that is, a so-called “white reference” or “black reference” are read by the line sensor 11. On the basis of the luminance data which is obtained in this operation and the reflection coefficient information of the objects, the luminance data read newly from the original is corrected. Accordingly, variations in brightness of the light sources for reading the original in the line direction (the direction of the straight line L), the influence of lowering of the amount of peripheral light at the light collecting lens for irradiation, or variations in line direction according to the light receiving sensitivity of the line sensor 11, are corrected.

The γ correction circuit 15 is a digital processing circuit that carries out γ correction processing to apply color adjustment for the luminance data of the R, G and B supplied from the shading correction circuit 14. For example, the color adjustment of the luminance data is carried out on the RGB color space which depends on the code of the color specification system of International Organization for Standardization “sRGB (standard RGB) color specification system”. The RGB color space is a color space used for expressing additive color mixing using three primaries of light (R, G, B), and the color becomes whiter with increase in value. The sRGB color specification system is employed in various types of image input/output equipment such as scanners, digital cameras, printers and monitors, and the difference in color between input and output is reduced by color adjustment based on the code of the sRGB color specification system.

The color space conversion circuit 16 is a digital processing circuit for converting the color space and outputting the color image data for the R, G, B luminance data supplied from the γ correction circuit 15. More specifically, processing to convert the RGB color space into a color space composed of luminance and hue, for example, the YCbCr color specification system, is carried out. The YCbCr color specification system is a color specification system used for JPEG image data and the like, in which Y designates luminance data and CbCr designates chromaticity data, respectively. In the chromaticity data CbCr, Cb designates the differential in blue (hue component) and Cr designates the differential in red (hue component). The color space conversion circuit 16 generates color image data including luminance data and chromaticity data for each pixel.

Instead of conversion into the YCbCr color specification system, conversion to the Lab color specification system which is one of the uniform color spaces may be employed. In the Lab color specification system, L designates luminance data and ab designates chromaticity data. In the chromaticity data ab, a and b designate hue components. The L component in the Lab color specification system is generally referred to as lightness. It is assumed that the luminance data in this specification includes L component data of the Lab color specification system, that is, lightness data.

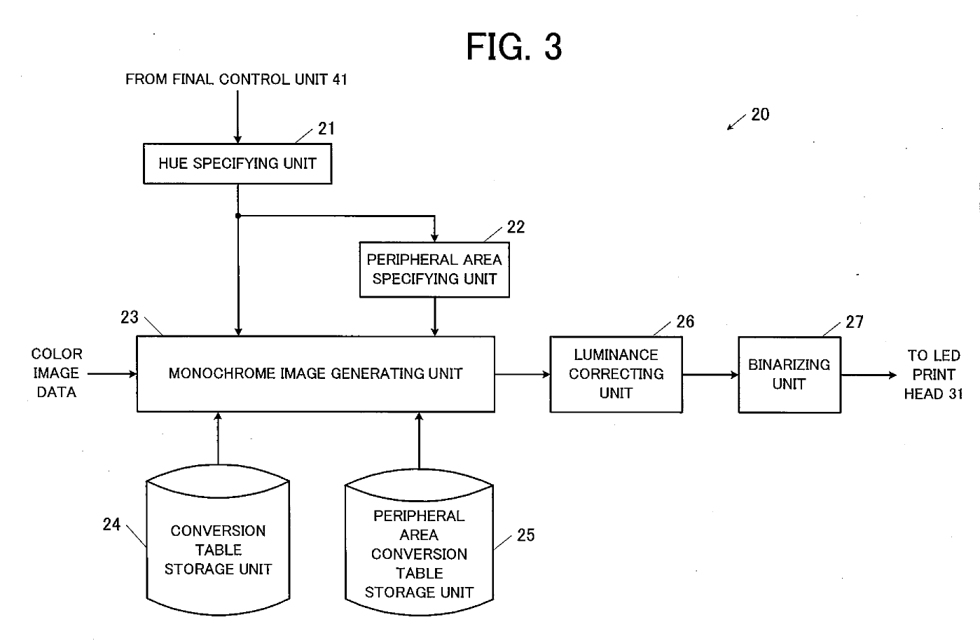

FIG. 3 is a block diagram of an image processing unit 20 of the digital multifunction peripheral 100 in FIG. 1. The image processing unit 20 includes a hue specifying unit 21, a peripheral area specifying unit 22, a monochrome image generating unit 23, a conversion table storage 24, a peripheral area conversion table storage 25, a luminance correcting unit 26 and a binarizing unit 27. The hue specifying unit 21 carries out an operation to generate hue specification information that specifies the hue whose luminance value is to be converted on the basis of the user operation.

In this hue specification, different hue components in the YCbCr color specification system Cb and Cr can be specified independently. It is assumed here that the color space is divided into a plurality of hue areas in advance, and one of these hue areas is selected by the user.

The peripheral area specifying unit 22 carries out an operation to generate peripheral area specification information for specifying the peripheral areas in the color space of a hue specified by the hue specification information on the basis of the color specifying information from the hue specifying unit 21. The peripheral areas specified by the peripheral area specification information are areas which are not overlapped with the user-specified hue area.

The conversion table storage 24 is a memory for storing a conversion table which saturate luminance values higher than the first threshold value and increase luminance values lower than the first threshold value. The conversion table gives correspondence information which defines correspondence of luminance values, and it is assumed here that a conversion table which lists input values of luminance before conversion processing existing in a range from a lower limit value to the first threshold value and corresponding output values of luminance after conversion processing obtained by multiplying these input values by a constant value is stored in advance.

The peripheral area conversion table storage 25 is a memory for storing a peripheral area conversion table in which the increment of the luminance value is smaller than the conversion table.

The monochrome image generating unit 23 carries out processing to extract pixels from the color image data on the basis of the hue specification information and the peripheral area specification information, and to convert luminance data of the extracted pixels on the basis of the conversion table and the peripheral area conversion table to generate monochrome image data.

The luminance correcting unit 26 carries out processing to correct the luminance to removing noise from monochrome image data received from the monochrome image generating unit 23. More specifically, the luminance correcting unit 26 carries out processing to convert luminance values existing in a first range including the lower limit value to the lower limit value, and to convert luminance values existing in a second range including the upper limit value to the upper limit value.

The hue determination, that is, the determination of the hue area to which the hue indicated by the chromaticity data belongs, is achieved accurately by performing processing to extract pixels from the color image and to convert luminance data to generate the monochrome image before the processing to correct luminance.

The binarizing unit 27 carries out processing to binarize the luminance data after conversion processing by the luminance correcting unit 26 by reducing the number of tones. More specifically, luminance values of the luminance data are compared with a predetermined (fourth) threshold value and, on the basis of the result of comparison, binary data is generated. The monochrome image data generated by the binarizing unit 27 and including binary data for each pixel is outputted to the LED print head 31.

It is assumed here that pseudo tone display processing (halftone display processing) such as a dither method is carried out to reproduce the change of monochrome multi-valued tone in binary when binarizing the luminance component. The pseudo tone display processing is image processing of a type in which threshold values for binarization are determined on a block basis including a plurality of pixels to obtain monochrome image data.

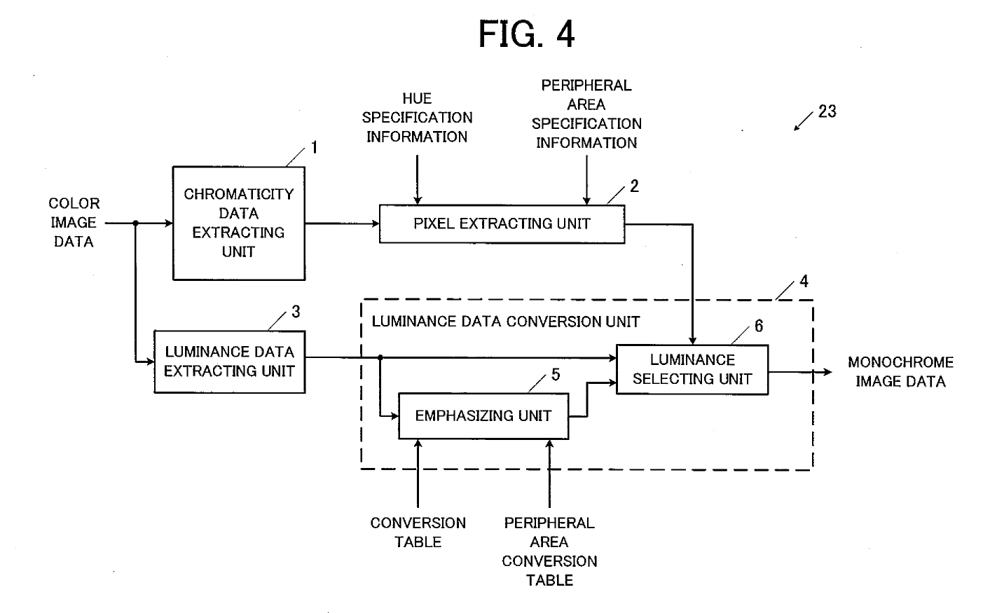

FIG. 4 is a block diagram of the monochrome image generating unit 23 in the image processing unit 20. The monochrome image generating unit 23 includes a chromaticity data extracting unit 1, a pixel extracting unit 2, a luminance data extracting unit 3 and a luminance data conversion unit 4. The chromaticity data extracting unit 1 carries out an operation to extract chromaticity data from color image data. More specifically, chromaticity data CbCr is extracted from color image data (YCbCr here) generated in the color space conversion circuit 16 and is outputted to the pixel extracting unit 2.

The pixel extracting unit 2 carries out an operation to extract pixels having a hue specified by hue specification information and peripheral area specification information on the basis of chromaticity data CbCr from the chromaticity data extracting unit 1.

More specifically, the hue area in the color space to which the pixels in question belong is determined on the basis of the hue component contained in the chromaticity data CbCr, and pixels which correspond to the user-specified hue area are extracted. Pixels which correspond to the hue area specified by the peripheral area specification information are also extracted.

The luminance data extracting unit 3 carries out an operation to extract luminance data from the color image data. More specifically, luminance data Y is extracted from the color image data YCbCr generated in the color space conversion circuit 16 and is outputted to the luminance data conversion unit 4.

The luminance data conversion unit 4 includes an emphasizing unit 5 and a luminance selecting unit 6, and carries out an operation to convert luminance data of pixels extracted by the pixel extracting unit 2 on the basis of the conversion table and to generate monochrome image data from the color image data.

The emphasizing unit 5 carries out processing to convert the luminance data Y on the basis of the conversion table read from the conversion table storage 24 and the peripheral area conversion table read from the peripheral area conversion table storage 25, and generates first luminance data and second luminance data increased in luminance value. More specifically, first luminance data is generated by converting the luminance value according to the conversion table. Second luminance data is generated by converting the luminance value according to the peripheral area conversion table.

The luminance selecting unit 6 carries out an operation to select luminance data on the basis of pixel extraction information from the pixel extracting unit 2 and to output the same as the monochrome image data. More specifically, first luminance data is selected for pixels extracted on the basis of hue specification information and second luminance data is selected on the basis of pixels extracted for peripheral area specification information. Luminance data Y is selected for pixels which are not extracted by the pixel extracting unit 2.

In the first embodiment, the conversion table which defines correspondence of the luminance value is used for carrying out conversion processing on luminance data of pixels extracted by the pixel extracting unit 2. However, it is also possible to employ processing on the basis of hardware using an arithmetic circuit instead of processing on the basis of software as described above.

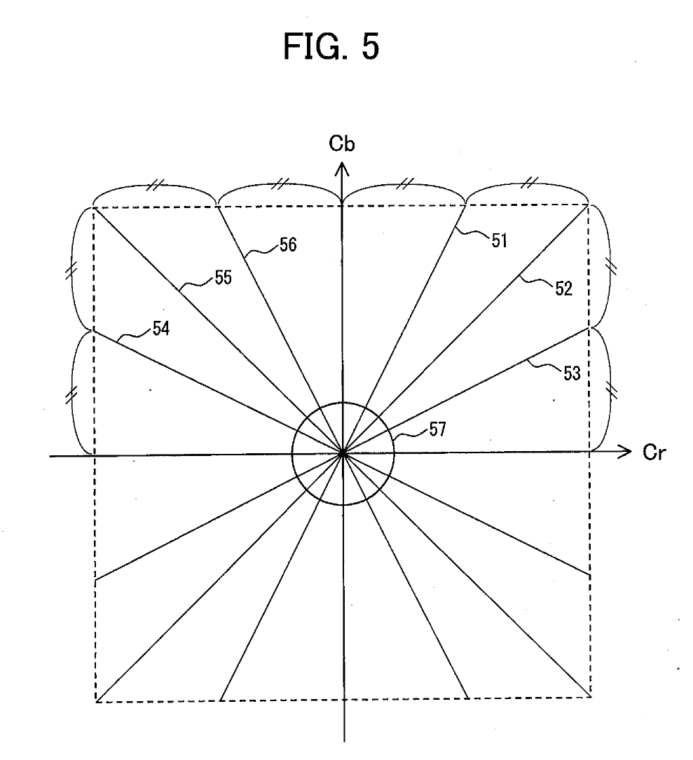

FIG. 5 illustrates a color space used when allowing a user to specify a hue in the image processing unit 20. The color space is the color space of the YCbCr color specification system with the value Cb as the vertical axis and the value Cr as the lateral axis. The larger the Cb component, the stronger the tincture of blue becomes, and the smaller the Cb component, the stronger the tincture of yellow becomes. In contrast, the larger the Cr component, the stronger the tincture of red becomes, and the smaller the Cr component, the stronger the tincture of green becomes.

It is assumed here that the color space is divided into sixteen hue areas by six straight lines 51-56 passing the original point, and the Cb axis and the Cr axis. The input range of the Cb component and the input range of the Cr component are assumed to be identical.

The straight line 51 represents a straight line with an inclination of 2, Cb=2Cr; the straight line 52 represents a straight line with an inclination of 1, Cb=Cr; and the straight line 53 represents a straight line with an inclination of ½, Cb=(½)Cr. The straight line 54 represents a straight line with an inclination of (−1)/2, (−2)Cb=Cr; the straight line 55 represents a straight line with an inclination of (−1), Cb=−Cr; and the straight line 56 represents a straight line with an inclination of (−2), Cb=(−2)Cr. The respective hue areas divided by these straight lines 51-56 have the same surface area.

The area near the original point of the color space is an achromatic color area 57 in which the absolute value of the hue component is small. The achromatic color (monotone) area 57 is an area showing a hue with low color saturation, and is defined by a predetermined relational equation established between the hue components Cb and Cr. In this example, the achromatic color area 57 is shown as the inside a circle about the original point.

The achromatic color area 57 is excluded from the hue as the target of conversion of the luminance value. That is, when extracting pixels from the color image on the basis of chromaticity data, only pixels having a color saturation larger than a predetermined (third) threshold value are extracted, and pixels having a color saturation smaller than the third threshold value are not extracted.

The hue area and the peripheral areas to be whitened from the monochrome image by changing the luminance value are specified for such color space.

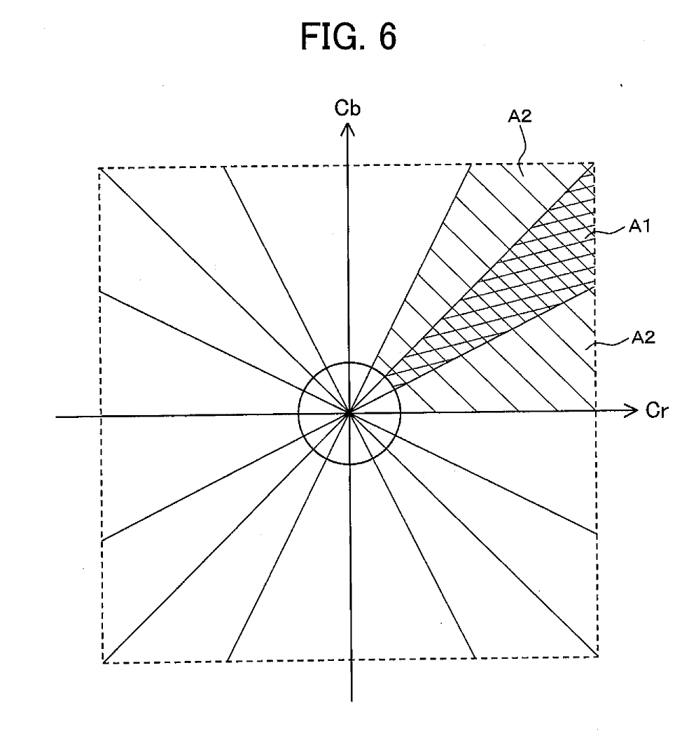

FIG. 6 illustrates a hue area A1 specified by the user and peripheral areas A2 in the image processing unit 20. In this example, the hue area A1 between the straight line 52 and the straight line 53 in a first quadrant is specified by the user, and two hue areas adjacent to the hue area A1 are specified as the peripheral areas A2. That is, the peripheral areas A2 are automatically specified on the basis of the position or the division in the color space of the hue area A1 when one hue area A1 is specified by the user.

The monochrome image generating unit 23 carries out processing to convert the luminance data of pixels whose hue belongs to the hue area A1 on the basis of the conversion table and to convert the luminance data of pixels whose hue belongs to the peripheral areas A2 on the basis of the peripheral area conversion table.

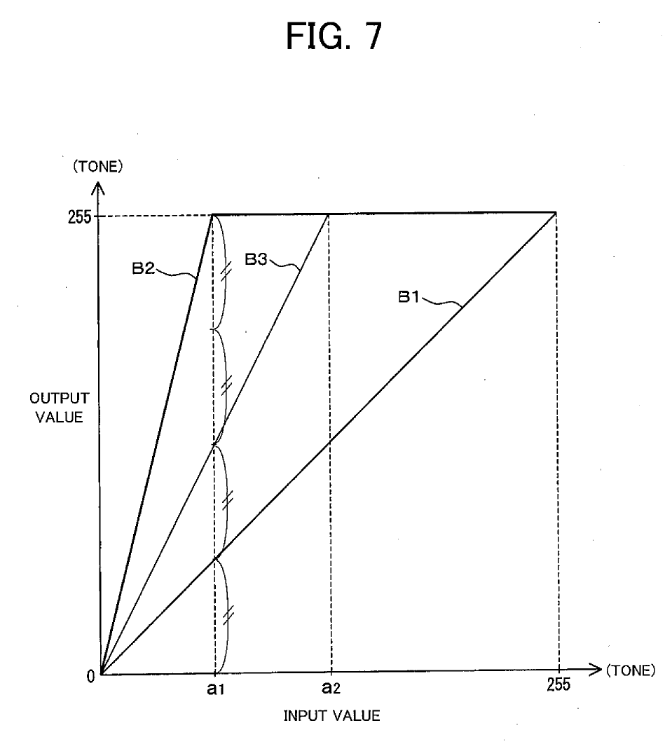

FIG. 7 illustrates graphs B2 and B3, which represent a conversion table used for changing the luminance value and whitening the specific hue by the image processing unit 20. Graph B1 is a straight line with an inclination of 1, and is a correspondence graph which brings input values of luminance into correspondence with output values of the same luminance.

The graph B2 is a sequential line showing the conversion table of pixels which belong to the user-specified hue area, which brings input values of luminance within a range from a first threshold value a1 to the upper limit value of luminance (saturated value) 255 into correspondence with the output value 255. The graph B2 also brings input values of luminance within a range from the lower limit value of luminance 0 to the first threshold value a1 into correspondence with output values increased in proportion to the luminance.

In this example, the coefficient of proportionality (the inclination of the straight line) of the graph B2 in the range from the lower limit value 0 to the first threshold value a1 is “4”, and a quarter of the upper limit value 255 corresponds to the first threshold value a1.

The graph B3 is a sequential line showing the peripheral area conversion table used for converting luminance data of pixels which belong to the peripheral area, and the increment of the luminance value is smaller than that of the graph B2. More specifically, input values of luminance within a range from a threshold value a2 to the upper limit value 255 are brought into correspondence with an output value of 255, and input values of luminance within a range from the lower limit value 0 to the threshold value a2 (&gt;a1) are brought into correspondence with the output value incremented in proportion to luminance. The coefficient of proportionality of the graph B3 in the range from the lower limit value 0 to the threshold value a2 is larger than “1”, which is smaller than the coefficient of proportionality of the graph B2.

In this example, the proportional coefficient of the graph B3 in the range from the lower limit value 0 to the threshold value a2 is “2”, and half of the upper limit value 255 corresponds to the threshold value a2.

The monochrome image generating unit 23 carries out processing to convert the luminance data on the basis of the conversion table shown by these graphs B2 and B3, so that the luminance data after the conversion processing is outputted as the monochrome image data.

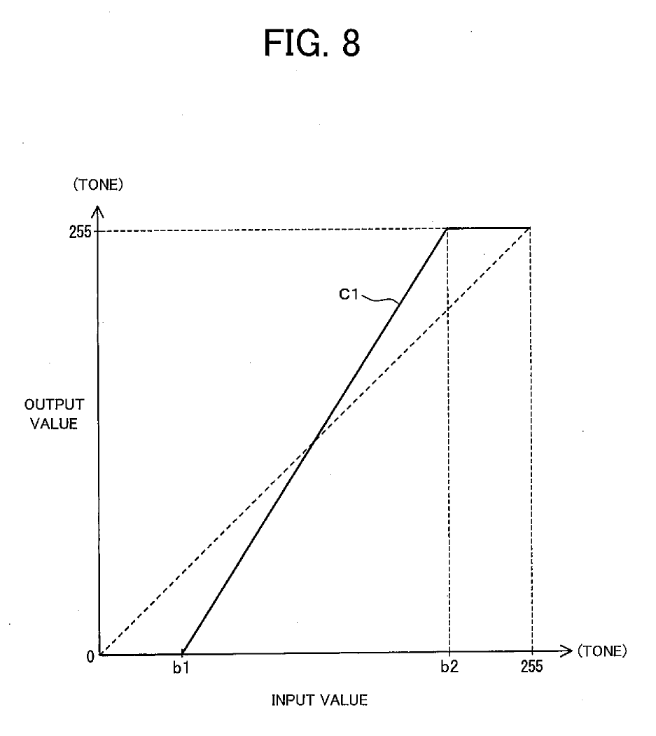

FIG. 8 illustrates a graph C1, which represents a conversion table used for correcting luminance for removing noise by the image processing unit 20. The graph C1 brings luminance values existing within a first range including the lower limit value 0 of luminance, that is, within a range from 0 to b1 inclusive into correspondence with the lower limit value 0, and brings luminance values existing within a second range including the upper limit value 255, that is, within a range from b2 to 255 inclusive into correspondence with the upper limit value 255. The graph C1 brings luminance values within a range from b1 to b2 inclusive into correspondence with luminance values obtained by multiplying the difference with respect to b1 by a constant value.

The luminance correcting unit 26 carries out conversion processing on the basis of the conversion table shown by the graph C1 for monochrome image data generated by the monochrome image generating unit 23. Since luminance values close to the upper limit value are saturated and luminance values close to the lower limit value are converted to the lower limit value by correcting the luminance on the basis of such conversion table, generation of black portions scattered in a white area as noise, or generation of white portions scattered in a black area as noise is restrained.

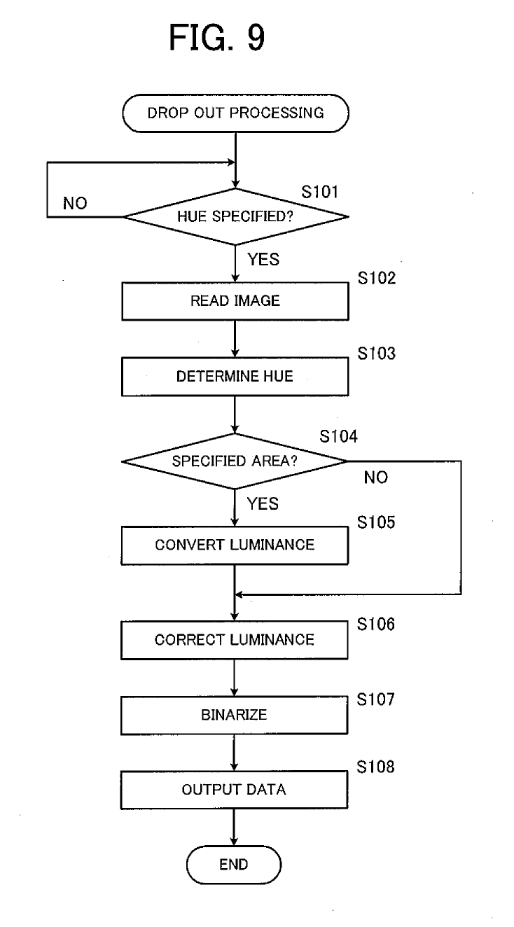

FIG. 9 is a flowchart of the operation of the image processing unit 20. The hue specifying unit 21 generates hue specification information when the hue area whose luminance value is to be converted is specified by the user (Step S101). The peripheral area specifying unit 22 generates peripheral area specification information on the basis of hue specification information when hue specification information is supplied from the hue specifying unit 21.

Subsequently, when hue specification information and peripheral area specification information are supplied, the monochrome image generating unit 23 reads color image data from the color scanner unit 10, determines whether or not pixels are those which belong to the specified area on the basis of the hue component of the chromaticity data, and extracts pixels which belong to the hue area specified by the hue specification information and pixels which belong to the peripheral areas specified by the peripheral area specification information (Steps S102 to S104).

At this time, the monochrome image generating unit 23 carries out conversion processing of luminance on the basis of the conversion table on luminance data of extracted pixels and generates monochrome image data (Step S105).

Subsequently, when monochrome image data is supplied from the monochrome image generating unit 23, the luminance correcting unit 26 carries out processing to correct the luminance for removing noise from the monochrome image data (Step S106). The binarizing unit 27 then carries out processing to reduce the number of tones on the monochrome image data after correction, and outputs the same as binary data (Steps S107, S108)

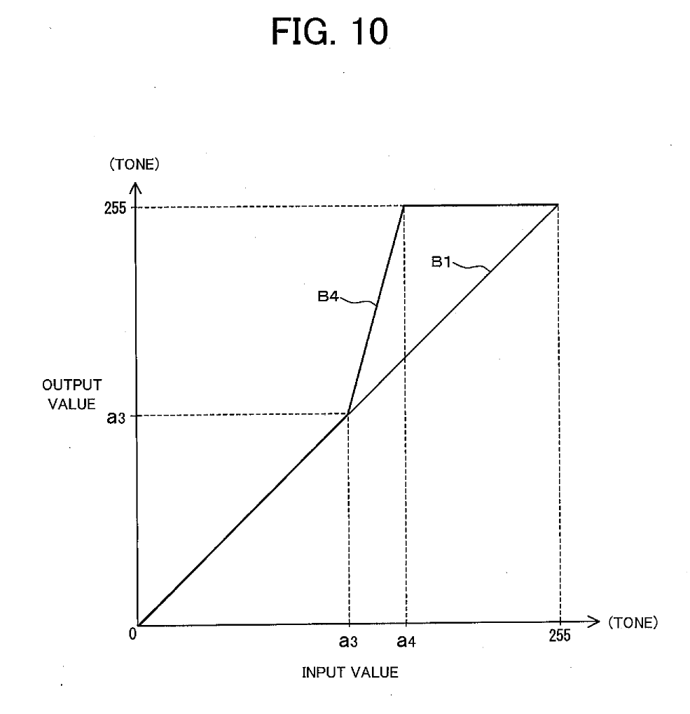

FIG. 10 illustrates a graph B4 which represents another example of the conversion table used by image processing unit 20 for changing the luminance value and whitening the specific hue. The graph B4 is a sequential line showing the conversion table for pixels which belong to the user-specified hue area. The graph B4 brings input values of luminance within a range from a first threshold value a4 to the upper limit value 255 into correspondence with the output value 255, increases input values of luminance higher than a second threshold value a3 (128 for example) which is smaller than the first threshold value a4 and lower than the first threshold value a4, and brings input values of luminance within a range from the lower limit value 0 to the second threshold value a3 into correspondence with the same luminance.

Here, input values of luminance within a range from the second threshold value a3 to the first threshold value a4 are brought into correspondence with output values obtained by multiplying the difference with respect to the threshold value a3 by a constant value. That is, the inclination of the straight line of the graph B4 is changed in two steps in a range from the lower limit value 0 and the first threshold value a4.

The luminance data may be converted using the conversion table shown by the graph B4 as described above, in which the inclination is changed in multiple steps between the lower limit value of luminance and the first threshold value. In this configuration, when luminance data is changed for pixels having the user-specified hue, the luminance value within a range from the lower limit value to the first threshold value is changed in multiple stages, and hence the boundary between black and white is restrained effectively from having a high profile when printed as a monochrome image.

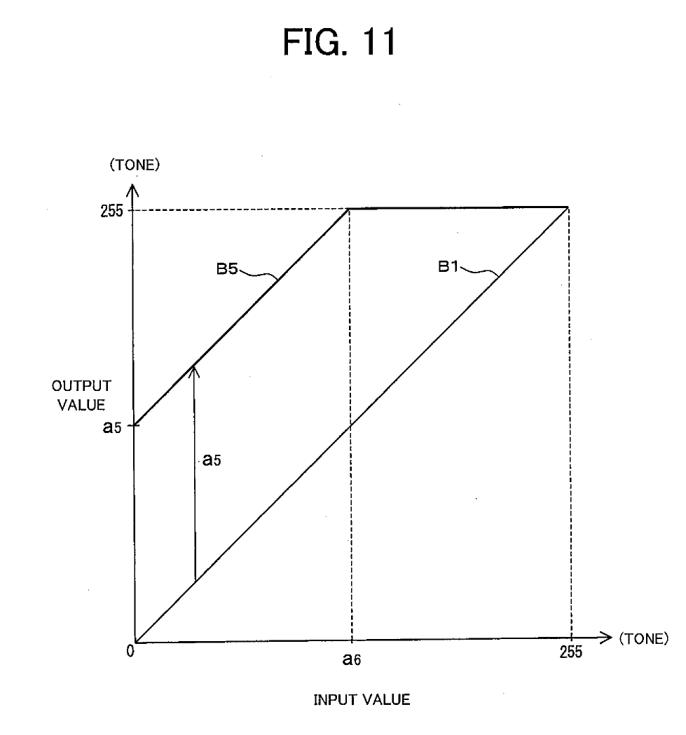

FIG. 11 illustrates a graph B5 which represents another example of the conversion table used in image processing unit 20 for changing the luminance value and whitening the specific hue. The graph B5 is a sequential line showing the conversion table for pixels which belong to the user-specified hue area. The graph B5 brings input values of luminance within a range from a first threshold value a6 to the upper limit value 255 into correspondence with the output value 255, and brings input values x of luminance within a range from the lower limit value 0 to the first threshold value a6 into correspondence with the output values (x+a5) increased by a constant value a5.

In the graph B5, the first threshold value a6 satisfies a relation of a6+a5=255. The luminance data may be converted using the conversion table shown by the graph B5 as described above.

According to the first embodiment, luminance data of pixels which belong to a user-specified hue area is changed according to the luminance value thereof and luminance values higher than the first threshold value are changed to the upper limit value of luminance. Therefore, the boundary between black and white is restrained from having a high profile when being printed as a monochrome image, and the specific hue can be whitened.

More specifically, in a case in which characters or the like are written in a writing paper with a pen in the same color as guide lines or a template preprinted in a pale color, for example, in red of high lightness (luminance), it is assumed that only the preprinted guide lines or the template is whitened to print a monochrome image without whitening characters written manually with a pen or objects printed in black. In the digital multifunction peripheral 100 according to the first embodiment, the preprinted guide lines or the template are adequately whitened while leaving the manually written characters, utilizing the fact that characters written with a pen on the writing paper are low in luminance (dense) in comparison with preprinted guide lines or the like.

According to the first embodiment, since extracting processing is carried out only on pixels having a larger color saturation than the third threshold value, pixels having a smaller color saturation different from the user-specific hue area are not extracted by mistake.

Since the luminance data of pixels in the peripheral area of the user-specified hue area is also converted according to the peripheral area conversion table, the boundary between the user-specified hue and a hue which is close to the user-specified hue in the color space is restrained from having a high profile when being printed as a monochrome image.

In the first embodiment, an application of the present invention to a digital multifunction peripheral having a scanner function for reading a color image from an original and a printer function for printing a monochrome image obtained from the read color image on a print sheet has been described as an example. However, the present invention is not limited thereto. For example, the present invention is also applicable to an image reading apparatus having only a scanning function, or a printing apparatus having only a printer function. The present invention is also applicable to a facsimile apparatus that converts a color image read from an original into monochrome image data, transmits the same to a destination and converts color image data received from another party into monochrome image data and prints the same on a print sheet.

In the first embodiment, the case in which one of the graph B2 in FIG. 7, the graph B4 in FIG. 10 or the graph B5 in FIG. 11 is used as a conversion table used for whitening a specific hue by changing the luminance value has been described as an example. However, a configuration in which the conversion to be used for whitening can be switched to either one of the conversion tables shown by these graphs as needed may also be employed. Alternatively, a configuration in which a plurality of conversion tables having different correspondences of luminance values according to the hue areas are provided, so that a conversion table corresponding to the user-specified hue area, if specified, is used for carrying out conversion processing of the luminance value, may also be employed.

In the first embodiment, the case in which luminance data Y is selected for pixels which are not extracted by the pixel extracting unit 2 has been described as an example. However, the present invention is not limited thereto. For example, a configuration in which processing to generate third luminance data by converting the luminance data Y extracted by the luminance data extracting unit 3 and lowering the luminance value is carried out, so that the third luminance data is selected for pixels which are not extracted by the pixel extracting unit 2.

In the first embodiment, the case in which processing to extract pixels and convert luminance data is carried out on the basis of color image data YCbCr generated by the color space conversion circuit 16 has been described as an example. However, the present invention is not limited thereto, and may be applied to a configuration in which color data on the basis of the RGB color space is supplied as color image data. When RGB data is supplied as color image data, the chromaticity data extracting unit 1 calculates the differences of color component (G−R) and (G−B) on the basis of the RGB data, and outputs the results as chromaticity data. The luminance data extracting unit 3 extracts the G component from the RGB data, and is outputted as the luminance data.

### Second Embodiment

In the first embodiment, the case in which the luminance value of pixels having a user-specified hue is increased to achieve whitening when being printed as a monochrome image has been described as an example. In contrast, in the second embodiment, the luminance value of pixels having the user-specified hue is lowered for emphasizing portions written in a specific color.

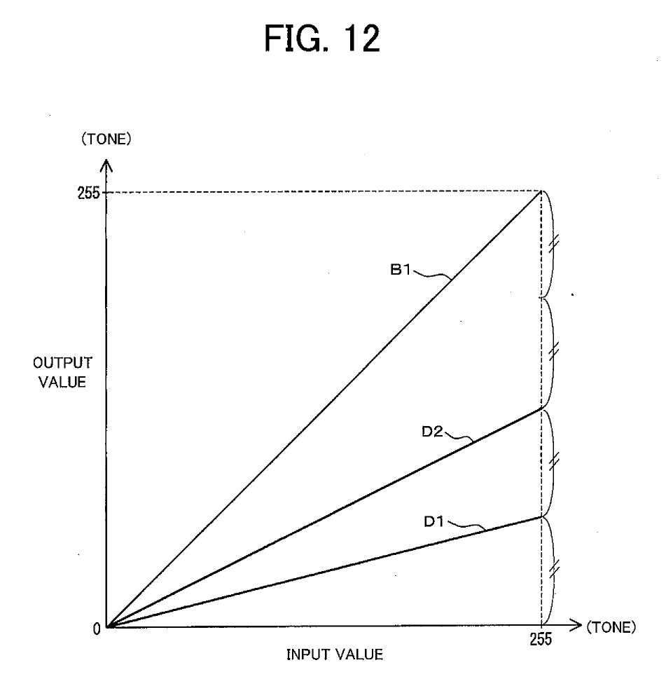

FIG. 12 illustrates graphs D1 and D2 which represent conversion tables used by an image processing apparatus according to the second embodiment of the invention for changing the luminance value and emphasizing the specific hue. The image processing apparatus according to the second embodiment is different from the digital multifunction peripheral 100 according to the first embodiment only in the conversion table used when changing the luminance value of pixels whose hue belong to a specific hue area. Other aspects are the same as the first embodiment.

The graph D1 is a straight line showing a conversion table used when changing the luminance value of pixels which belong to a user-specified hue area. The graph D1 brings input values of luminance within a range from the lower limit value 0 to the upper limit value (saturated value) 255 of luminance into correspondence with output values having been lowered in proportion to the luminance. That is, the graph D1 is a correspondence graph which brings luminance values into correspondence with values obtained by multiplying the luminance values by a constant value. In this example, the coefficient of proportionality (the inclination of the straight line) of the graph D1 is “1/4” and, for example, the input value 255 corresponds to an integer number 63 or 64, which is close to 255/4 as the output value. It is assumed here that the input value and the output value are both integer numbers and, when the output value on the graph D1 corresponding to the input value is a decimal number, the fractions below decimal point are rounded up or down, or rounded off.

The graph D2 is a straight line showing a peripheral area conversion table used when changing the luminance value of pixels whose hue belong to the peripheral areas. The graph D2 is smaller in ratio of lowering of the luminance value in comparison with the graph D1. More specifically, the coefficient of proportionality of the graph D2 is smaller than one, and is larger than the coefficient of proportionality of the graph D1. In this example, the coefficient of proportionality of the graph D2 is “1/2” and, for example, the input value 255 is brought into correspondence with the output value 255/2.

The monochrome image generating unit 23 carries out processing to convert luminance data on the basis of the conversion table shown by the graphs D1 and D2, and the luminance data after conversion processing is outputted as monochrome data. The conversion table used for processing to convert luminance data as described above may be any type as long as the function for defining the correspondence of the luminous value within a predetermined range including the upper limit value 255 increases in a monotone.

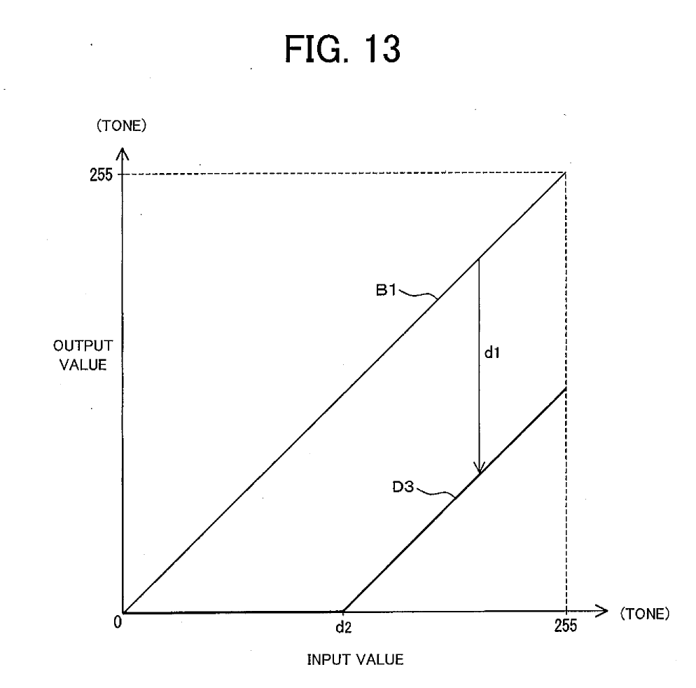

FIG. 13 illustrates a graph D3 which represents another example of a conversion table used by the image processing apparatus of the second embodiment of the invention for changing the luminance value and emphasizing the specific hue. The graph D3 is a sequential line showing a conversion table of pixels which belong to the user-specified hue area.

In the graph D3, input values of luminance within the range from the lower limit value 0 to the first threshold value d2 of luminance are brought into correspondence with the output value 0, and input values x of luminance within the range from the first threshold value d2 to the upper limit value 255 are brought into correspondence with output values reduced by a constant value d1 (x−d1). That is, the graph D3 brings luminance values existing within the range from the lower limit value 0 to the first threshold value d2 into correspondence with the lower limit value 0, and luminance values existing within the range from the first threshold value d2 to the upper limit value 255 into correspondence with values obtained by reducing a constant value d1 from the luminance values.

In the graph D3, the first threshold value d2 satisfies a relation of d2−d1=0. The luminance data may be converted using the conversion table shown by the graph D3 as described above.

According to the second embodiment, since the luminance value of pixels in the user-specified hue area is lowered, the specific hue is printed densely when being printed as a monochrome image, and the corresponding portion may be emphasized.

More specifically, specific portions such as characters written in red pen on an original having guide lines or a template preprinted in black may be emphasized when being printed. In particular, it is possible to increase density and emphasize the specific portions such as the characters written in red and decrease density of other portions printed in black when printing.

### Third Embodiment

In the second embodiment, the case in which luminance values of pixels in the user-specified hue area are lowered has been described as an example. In contrast, in the third embodiment, luminance values of pixels which belong to a user-specified hue area are lowered, and luminance values of pixels which do not belong to the hue area are increased.

In the image processing apparatus according to the third embodiment, luminance values of pixels which belong to a hue area specified by a hue specification information are changed on the basis of the conversion table. That is, processing to lower luminance values is carried out on these pixels. On the other hand, processing to increase luminance values is carried out for pixels which do not belong to the hue area specified by the hue specification information.

In this configuration, the luminance values for pixels in the user-specified hue area are lowered, and the luminance values of other pixels are increased, so that portions having a specific hue can be emphasized more when being printed as a monochrome image.

While the present invention has been described with respect to embodiments thereof, it will be apparent to those skilled in the art that the disclosed invention may be modified in numerous ways and may assume many embodiments other than those specifically set out and described above. Accordingly, it the appended claims are intended to cover all modifications that fall within the true spirit and scope of the present invention.

What is claimed is:

1. An image processing apparatus comprising:
a hue specifying unit that generates hue specification information that specifies a hue to be converted on a basis of a user operation;
a pixel extracting unit that extracts pixels having a hue specified by the hue specification information from a color image on a basis of the hue obtained from chromaticity data; and
a luminance data converting unit that carries out conversion processing on luminance data of pixels extracted by the pixel extracting unit to saturate luminance values higher than a first threshold value and increase luminance values lower than the first threshold value, so that a monochrome image is generated from the color image.

2. The image processing apparatus according to claim 1, wherein the luminance data converting unit brings luminance values in a range from a lower limit value to the first threshold value into correspondence with values obtained by multiplying the luminance values by a constant value.

3. The image processing apparatus according to claim 1, wherein the luminance data converting unit saturates luminance values higher than the first threshold value, increases luminance values higher than a second threshold value which is smaller than the first threshold value and lower than the first threshold value, and brings luminance values lower than the second threshold value into correspondence with a same luminance.

4. The image processing apparatus according to claim 1, wherein the pixel extracting unit extracts pixels having a color saturation larger than a third threshold value and does not extract pixels having a color saturation smaller than the third threshold value when extracting pixels from the color image on the basis of the hue obtained from the chromaticity data.

5. The image processing apparatus according to claim 1 comprising:
a binarizing unit that compares the luminance value of the luminance data after conversion processing by the luminance data converting unit with a fourth threshold value and, on a basis of a result of comparison, generates binary data,
wherein the monochrome image including the binary data for each pixel is outputted.

6. The image processing apparatus according to claim 5 comprising:
a luminance correcting unit that carries out processing to convert luminance values existing in a first range including the lower limit value in the luminance data after conversion processing by the luminance data converting unit into the lower limit value, or to convert luminance values existing in a second range including an upper limit value into the upper limit values,
wherein the binarizing unit generates the binary data on a basis of the luminance data after conversion processing by the luminance correcting unit.

7. The image processing apparatus according to claim 1 comprising:
a peripheral area specifying unit that generates peripheral area specification information that specifies peripheral areas in a color space having a hue specified by the hue specification information on a basis of the hue specification information,
wherein the luminance data conversion unit converts luminance data in pixels in the peripheral areas specified by the peripheral area specification information with an increment of the luminance value smaller than the conversion processing to generate the monochrome image from the color image.

8. An image processing method comprising:
a hue specifying step for generating hue specification information that specifies a hue to be converted on a basis of a user operation;
a pixel extracting step for extracting pixels having a hue specified by the hue specification information from a color image on a basis of the hue obtained from chromaticity data; and
a luminance data converting step for carrying out conversion processing on luminance data of pixels extracted in the pixel extracting step to saturate luminance values higher than a first threshold value and increase luminance values lower than the first threshold value, so that a monochrome image is generated from the color image.

9. The image processing method according to claim 8,
wherein pixels having a color saturation larger than a threshold value are extracted and pixels having a color saturation smaller than the threshold value are not extracted when extracting pixels in the pixel extracting step.

10. The image processing method according to claim 8 comprising:
a peripheral area specifying step for generating peripheral area specification information that specifies peripheral areas in a color space having a hue specified by the hue specification information on a basis of the hue specification information,
wherein the luminance data conversion step converts luminance data in pixels in the peripheral areas specified by the peripheral area specification information with an increment of the luminance value smaller than the conversion processing to generate the monochrome image from the color image.

11. An image processing apparatus comprising:
a hue specifying unit that generates hue specification information that specifies a hue to be converted on a basis of a user operation;
a pixel extracting unit that extracts pixels having a hue specified by the hue specification information from a color image on a basis of the hue obtained from the chromaticity data; and
a luminance data converting unit that carries out processing on luminance data of pixels extracted by the pixel extracting unit using a function that lowers an upper limit value of luminance and increases in a monotone within a predetermined range including the upper limit value to convert the luminance value, so that a monochrome image is generated from the color image.

12. The image processing apparatus according to claim 11,
wherein the luminance data converting unit brings the luminance values into correspondence with values obtained by multiplying the luminance values by a constant value.

13. The image processing apparatus according to claim 11,
wherein the luminance data converting unit brings luminance values existing in a range from a lower limit value to a first threshold value into correspondence with the lower limit value, and brings luminance values existing in the range from the first threshold value to the upper limit value into correspondence with values obtained by subtracting a constant value from the luminance values.

14. The image processing apparatus according to claim 11,
wherein the pixel extracting unit extracts pixels having a color saturation larger than a second threshold value and does not extract pixels having a color saturation smaller than the second threshold value when extracting pixels from the color image on a basis of the hue obtained from the chromaticity data.

15. The image processing apparatus according to claim 11 comprising:
a binarizing unit that compares the luminance value of the luminance data after conversion processing by the luminance data converting unit with a third threshold value and, on a basis of the result of comparison, generates binary data, wherein the monochrome image including the binary data for each pixel is outputted.

16. The image processing apparatus according to claim 15 comprising:
a luminance correcting unit that carries out processing to convert luminance values existing in a first range including the lower limit value in the luminance data after conversion processing by the luminance data converting unit into the lower limit value, or to convert luminance values existing in a second range including the upper limit value into the upper limit value,
wherein the binarizing unit generates the binary data on a basis of the luminance data after conversion processing by the luminance correcting unit.

17. The image processing apparatus according to claim 11,
wherein the luminance data converting unit increases the luminance value for pixels other than those having a hue specified by the hue specification information.

18. The image processing apparatus according to claim 11 further comprising:
a peripheral area specifying unit that generates peripheral area specification information that specifies peripheral areas in a color space having a hue specified by the hue specification information on a basis of the hue specification information,
wherein the luminance data conversion unit converts luminance data in pixels in the peripheral areas specified by the peripheral area specification information with an increment of the luminance value smaller than the conversion processing to generate the monochrome image from the color image.

19. An image processing method comprising:
a hue specifying step for generating hue specification information that specifies a hue to be converted on a basis of a user operation;
a pixel extracting step for extracting pixels having a hue specified by the hue specification information from a color image on the basis of the hue obtained from chromaticity data; and
a luminance data converting step for carrying out processing on luminance data of pixels extracted in the pixel extracting step using a function which lowers an upper limit value of luminance and increases in a monotone within a predetermined range including the upper limit value to convert the luminance value, so that a monochrome image is generated from the color image.

20. The image processing method according to claim 19,
wherein pixels having a color saturation larger than a threshold value are extracted and pixels having a color saturation smaller than the threshold value are not extracted when extracting pixels in the pixel extracting step.
